(19) United States
(12) Patent Application Publication
(10) Pub. No.: US 2025/0014142 A1
(43) Pub. Date: Jan. 9, 2025

(54) SYSTEMS AND METHODS FOR USER INTERACTIVE GEOREGISTRATION

(71) Applicant: Palantir Technologies Inc., Denver, CO (US)

(72) Inventors: Ethan Van Andel, Berkeley, CA (US); Joseph Driscoll, Bentleyville, OH (US); Stephen Ramsey, Mountain View, CA (US); Mary Cameron, Washington, DC (US); Matthew Betten, West Lebanon, NH (US); Matthew Fedderly, Baltimore, MD (US); Duyen Luu Hai, Arvada, CO (US); Luke Wing, New York, NY (US); Dimitrios Lymperopoulos, Kirkland, WA (US)

(21) Appl. No.: 18/757,155

(22) Filed: Jun. 27, 2024

Related U.S. Application Data
(60) Provisional application No. 63/525,440, filed on Jul. 7, 2023.

(51) Int. Cl. G06T 3/14; G06T 7/33

(52) U.S. Cl. CPC G06T 3/14; G06T 7/337; G06T 2207/10016; G06T 2207/20101

(57) ABSTRACT

Systems and methods for georegistration are provided. An example method includes receiving a video stream including a plurality of video frames collected by an image sensor, presenting the video stream via a video player, and receiving user input associated with a first video frame of the plurality of video frames and a reference image. In some examples, the first video frame includes incomplete telemetry data. In some examples, the method further includes determining one or more coordinates associated with the first video frame based on user input associated with the first video frame and the reference image, determining the incomplete telemetry data associated with the first video frame based on the one or more determined coordinates, and generating a georegistration transform based on the determined telemetry data and the reference image.

### CROSS REFERENCE TO RELATED APPLICATIONS

This application claims priority to U.S. Provisional Application No. 63/525,440, entitled “SYSTEMS AND METHODS FOR USER INTERACTIVE GEOREGISTRATION,” and filed on Jul. 7, 2023, which is incorporated by reference herein for all purposes in its entirety.

### TECHNICAL FIELD

Certain embodiments of the present disclosure relate to georegistration. More particularly, some embodiments of the present disclosure relate to aligning received images, such as satellite images, with a coordinate location.

### BACKGROUND

Georegistration is a process for aligning two or more images or datasets spatially to a common coordinate system. In some examples, georegistration involves finding a transformation that maps points in one image or dataset to corresponding points in another image or dataset.

Hence, it is desirable to improve techniques for georegistration.

### SUMMARY

Certain embodiments of the present disclosure relate to georegistration. More particularly, some embodiments of the present disclosure relate to aligning received images, such as satellite images, with a coordinate location.

At least some aspects of the present disclosure are directed to a method for georegistration. In some embodiments, the method includes: receiving a video stream including a plurality of video frames collected by an image sensor, presenting the video stream via a video player, and receiving user input associated with a first video frame of the plurality of video frames and a reference image. In some embodiments, the first video frame includes incomplete telemetry data. In some embodiments, the method further includes determining one or more coordinates associated with the first video frame based on user input associated with the first video frame and the reference image, determining the incomplete telemetry data associated with the first video frame based on the one or more determined coordinates, and generating a georegistration transform based on the determined telemetry data and the reference image. In some embodiments, the method is performed using one or more processors.

At least some aspects of the present disclosure are directed to a system for georegistration. In some embodiments, the system includes at least one processor and at least one memory storing instructions that, when executed by the at least one processor, causes the system to perform a set of operations. In some embodiments, the set of operations includes: receiving a video stream including a plurality of video frames collected by an image sensor, presenting the video stream via a video player, and receiving user input associated with a first video frame of the plurality of video frames and a reference image. In some embodiments, the first video frame includes incomplete telemetry data. In some embodiments, the set of operations further includes determining one or more coordinates associated with the first video frame based on user input associated with the first video frame and the reference image, determining the incomplete telemetry data associated with the first video frame based on the one or more determined coordinates, and generating a georegistration transform based on the determined telemetry data and the reference image.

At least some aspects of the present disclosure are directed to a method for georegistration. In some embodiments, the method includes: receiving a video stream including a plurality of video frames collected by an image sensor, presenting the video stream via a video player, and receiving user input associated with a first video frame of the plurality of video frames and a reference image. In some embodiments, the first video frame includes incomplete telemetry data. In some embodiments, the incomplete telemetry data includes at least a piece of missing telemetry data or at least a piece of unreliable telemetry data. In some embodiments, the method further includes determining one or more coordinates associated with the first video frame based on user input associated with the first video frame and the reference image, determining the incomplete telemetry data associated with the first video frame based on the one or more determined coordinates, generating a georegistration transform based on the determined telemetry data and the reference image, applying the georegistration transform to one or more video frames of the plurality of video frames to generate one or more registered video frames, and presenting the one or more registered video frames via the video player. In some embodiments, the method is performed using one or more processors.

Depending upon embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 is an illustrative diagram for a georegistration environment or workflow, according to certain embodiments of the present disclosure.

FIG. 2 is an illustrative diagram for a software architecture and workflow for a georegistration system, according to certain embodiments of the present disclosure.

FIG. 3 is a simplified diagram showing a method for georegistration, according to certain embodiments of the present disclosure

FIG. 4 is an illustrative example of a user interface, according to certain embodiments of the present disclosure.

FIG. 5 is a simplified diagram showing a software architecture for a video georegistration system, according to certain embodiments of the present disclosure.

FIG. 6 is a simplified diagram showing a method for video georegistration, according to certain embodiments of the present disclosure.

FIG. 7 is a simplified diagram showing a method for generating an image transformation, according to certain embodiments of the present disclosure.

FIG. 8 is a simplified diagram showing a computing system for implementing a system for georegistration, according to certain embodiments of the present disclosure.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein. However, some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input. For example, predicting an outcome based on a particular piece of information may additionally, or alternatively, base the same determination on another piece of information. As used herein, the term “receive” or “receiving” means obtaining from a data repository (e.g., database), from another system or service, from another software, or from another software component in a same software. In certain embodiments, the term “access” or “accessing” means retrieving data or information, and/or generating data or information.

Conventional systems and methods are often lack of ways to conduct georegistrations without telemetry data. Conventional systems and methods typically use telemetry data to identify reference images for georegistrations, and without adequate telemetry data, georegistration cannot be conducted.

Various embodiments of the present disclosure can achieve benefits and/or improvements by a computing system, for example, using user interactive inputs for georegistrations. In some embodiments, benefits include significant improvements, including, for example, generating location information and conducting georegistrations, even if the telemetry data is not available and/or the complete telemetry data is not available. In certain embodiments, other benefits include improved accuracy for georegistrations, for example, using user inputs and/or object recognitions based on user inputs. In some embodiments, benefits further include capability of processing user input and/or pairs of user inputs to one or more video frames and corresponding user inputs and/or object recognitions to reference images. In certain embodiments, systems and methods are configured to use user inputs for georegistration.

According to certain embodiments, systems (e.g., navigation systems, mapping systems, surveying systems) may utilize unmanned aircrafts (UAs) (e.g., unmanned aerial vehicles, unmanned aerial systems, drones) with camera feeds to monitor and analyze areas of interest. In some embodiments, as used herein, an aircraft refers to an aircraft, an unmanned aircraft, an unmanned aerial vehicle (UAV), an unmanned aerial system (UAS), a large unmanned aerial system (LUAS), a drone, and/or the like. In certain embodiments, a full motion video (FMV) may be collected from one or more sensors on aerial or ground assets, where the FMV is an important asset. In some embodiments, georegistering FMV (assigning accurate geo-coordinates to some or every frame) is important to enabling various workflows. In some embodiments, georegistration, also known as image registration or geometric registration, is a process for aligning two or more images or datasets spatially to a common coordinate system. In certain embodiments, georegistration involves finding a transformation that maps points in one image or dataset to corresponding points in another image or dataset. In some embodiments, georegistration is a resource-intense process that needs substantial computing resources.

In certain embodiments, some video capturing systems (e.g., cameras on large unmanned aerial systems (LUAS)) can provide detailed telemetry, such that the georegistration process is focused on improving the accuracy of existing geo-coordinates, also referred to as geospatial coordinates. In some embodiments, telemetry data includes location, position, speed, elevation gain, GPS (global positioning system) data, attitude, geospatial coordinates, scale, rotation, heading, orientation, viewing angle, field of view, and/or the like. In certain embodiments, telemetry data includes or is metadata of a video stream, an image sensor, and/or an edge device integrated with or on a carrying object (e.g., an aircraft, a vehicle, etc.). In some embodiments, in a practical implementation, some video capturing systems (e.g., cameras on small unmanned aerial systems (SUAS)) lack complete telemetry, such that the georegistration process requires determining geospatial coordinates without telemetry or without complete telemetry to start from. In certain embodiments, complete telemetry data for an image sensor includes geospatial coordinates of captured video frames, rotation, and scale.

According to certain embodiments, user interactive georegistration, also referred to as user centered georegistration (UCGR), for example, performing georegistration using user inputs, is a technique to enable an informed user to manually provide geocoordinates for video frames and use that to georegister the video (e.g., the entire video).

According to some embodiments, the georegistration system receives video streams captured by one or more image sensors. In certain embodiments, the georegistration system receives video streams captured by one or more types of image sensors. In some embodiments, the georegistration implementation uses an image matching technique that works both within and across two or more sensor types including, for example, electro-optical (EO) sensor type, infrared (IR) sensor type, synthetic aperture radar (SAR) sensor type, and/or the like. In certain embodiments, such georegistration implementation has one or more advantages over other techniques that only work with a single type of data.

In certain embodiments, a georegistration system (e.g., a georegistration service) is configured to receive (e.g., obtain) a video from a video recording platform (e.g., an imaging sensor on an aircraft) with location information (e.g., telemetry data) and align the received video with a reference image (e.g., a dynamic reference frame, a reference frame, a reference imagery, a map) so the georegistration system can determine the geospatial coordinates, also referred to as geo-coordinates or coordinates, of the video.

According to certain embodiments, a georegistration system incorporates one or more techniques including, for example, georectification, orthorectification, orthorectification, and/or the like. In some embodiments, georectification refers to assigning geo-coordinates to an image. In certain embodiments, orthorectification refers to warping an image to match the top-down view. In some examples, orthorectification includes reshaping hillsides and such so it looks like the image was taken directly from overhead rather than at a side angle. In some embodiments, georegistration refers to refining the geo-coordinates of a video, for example, based on reference data.

In certain embodiments, georegistration (e.g., image registration) refers to, given an input image and one or more reference images, finding a transform mapping the input image to the corresponding part of the one or more reference images. In some embodiments, georegistration for a video refers to, given an input video and one or more reference images, finding a transform or a sequence of transforms mapping the input video including one or more video frames to the corresponding part of the one or more reference images and use the transforms to generate the registered video. In certain embodiments, image/video georegistration has one or more challenges: 1) images/videos have visual variations, for example, lighting changes, temporal changes (e.g., seasonal changes), sensor mode (e.g., electro-optical (EO), infrared (IR), synthetic-aperture radar (SAR), etc.); 2) images/videos have minimal structured content (e.g., forest, fields, water, etc.); 3) images/videos have noise (e.g., image noise for SAR images); and 4) images/videos have rotation, scale, and/or perspective changes.

According to some embodiments, a georegistration system includes one or more SIP (sensor inference platform) modules (e.g., a software orchestrator, a model orchestrator, a sensor orchestrator, etc.). In certain embodiments, the SIP modules may run in parallel on one or more processors. In some embodiments, a processor refers to a computing unit implementing a model (e.g., a computational model, an algorithm, an AI model, etc.). In certain embodiments, a model, also referred to as a computing model, includes a model to process data. A model includes, for example, an AI model, a machine learning (ML) model, a deep learning (DL) model, an image processing model, an algorithm, a rule, other computing models, and/or a combination thereof.

According to some embodiments, the georegistration system is configured to receive a video (e.g., a streaming video) and choose video frames (e.g., video images) and selected derivations (e.g., derived composites of multiple video frames, a pixel grid of a video frame, etc.) in video frames, also referred to as templates (e.g., 60 by 60 pixels). In certain embodiments, a video georegistration uses selected video frames (e.g., every one second) and templates that can be less time-consuming. In some embodiments, the georegistration system performs georegistration of the templates, collects desirable matches, computes image transformation and generates a sequence of registered video frames (e.g., georegistered video frames) and a registered video (e.g., georegistered video).

According to certain embodiments, the georegistration system computes an image representation (e.g., one or more feature descriptors, one or more image vectors) of the templates for georegistration. In some embodiments, the georegistration system computes the angle weighted oriented gradients (AWOG) representation of the templates for georegistration. In certain embodiments, the georegistration system compares the AWOG representation of the template with reference imagery (e.g., reference image) to determine a match and/or a match score, for example, the template sufficiently matched (e.g., 100%, 80%) the reference imagery. In some embodiments, the georegistration system reiterates the process to find enough matched templates. According to certain embodiments, the georegistration system uses the matched templates to perform georegistration of the image or the video frame. In some embodiments, the matched templates might be noisy and/or irregular.

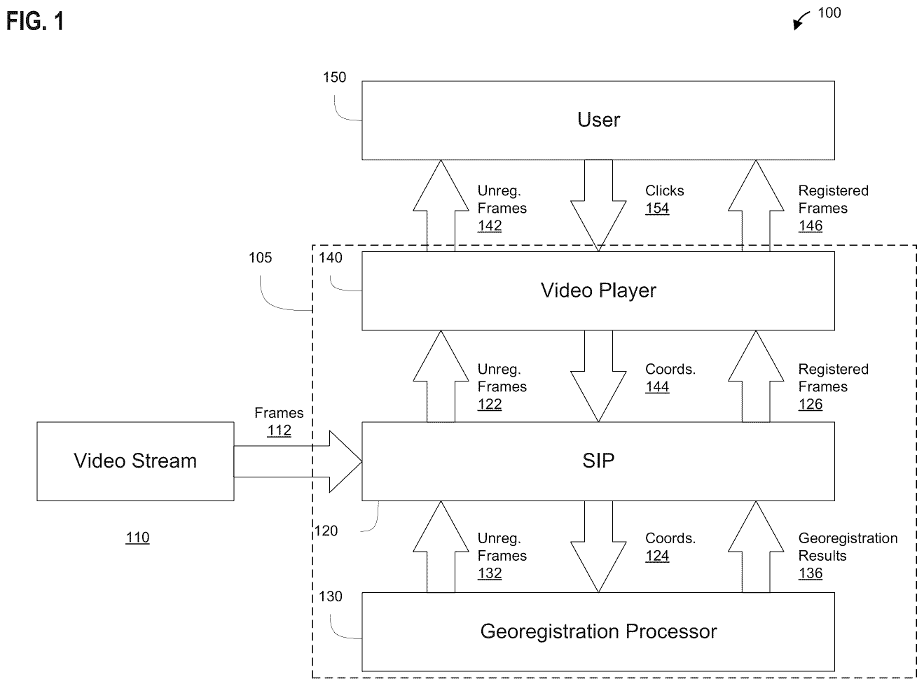

FIG. 1 is an illustrative diagram for a georegistration environment or workflow 100, according to certain embodiments of the present application. FIG. 1 is merely an example. One of the ordinary skilled in the art would recognize many variations, alternatives, and modifications. For example, some of the components may be expanded, integrated, and/or combined. Other components may be inserted into those noted above. Depending upon the embodiment, the arrangement of components may be interchanged with others replaced. Further details of these components are found throughout the present disclosure.

According to certain embodiments, the georegistration environment or workflow 100 includes one or more video streams 110 (e.g., videos captured in real time, videos captured continuously, etc.), a georegistration system 105, and one or more users 150 (e.g., user devices interacting with users). In some embodiments, the georegistration system 105 includes one or more SIPs 120, one or more georegistration processors 130, and one or more video players 140. In certain embodiments, the one or more video players 140 can be on a user device. In some embodiments, the one or more video streams 110 are captured by one or more image sensors. In certain embodiments, the one or more video streams 110 are captured by one or more image sensors on or integrated with one or more aircrafts.

According to certain embodiments, a georegistration system 105 receives a video stream 110 including one or more frames 112. In some examples, the video stream 110 is fed into SIP 120. In certain embodiments, the georegistration processor 130 receives the video stream and/or the one or more frames 112. In some embodiments, the SIP 120 passes the one or more video frames to the video player 140, which is then played to a user 150. In certain embodiments, at least a part of the video frames 112 are unregistered frames. In some embodiments, the user 150 activates the user-centered georegistration workflow, which involves the user 150 clicking 154 on one or more points in the video frame. In certain embodiments, a click 154 pauses the video player 140, so that a specific video frame 112 is shown in the video player 140.

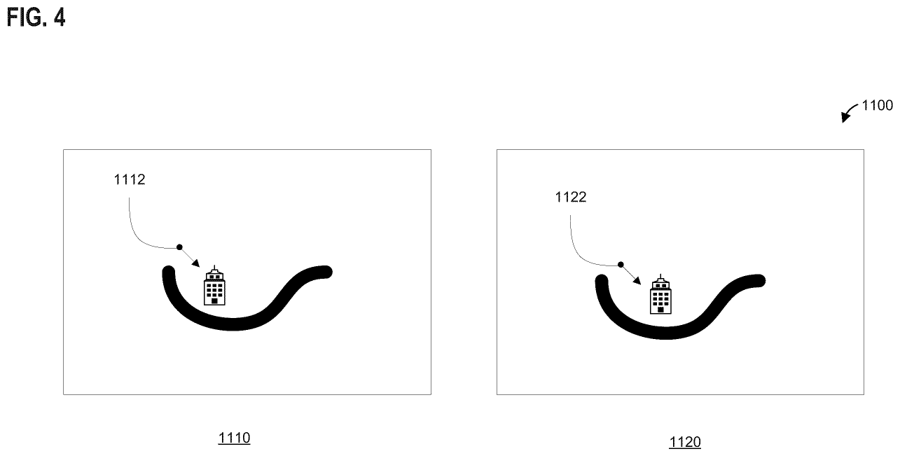

According to some embodiments, the user 150 can scroll a reference image (e.g., a reference imagery, a reference map, a base map, a satellite image, etc.), to find the general location of the video frames. For example, if a video frame has a tennis court, the user may scroll the reference image until a tennis court is found in the reference image. In certain embodiments, the user 150 can click on a pixel or a target of interest in the video frame 112, then click a spot on the reference image, indicating this pixel corresponds to these coordinates of the spot in the map. In some embodiments, a pixel click corresponds to a video frame location, also referred to as a video frame point, and a spot click corresponds to a reference image location, also referred to as a reference image point, that is a location in the reference imagery. In some embodiments, the user 150 may click four or more times to generate two or more pairs of video frame locations and reference image locations. In some embodiments, the user 150 may click eight or more times to generate four or more pairs of video frame locations and reference image locations. As an example, FIG. 4 is an illustrative example of a user interface 1100. In this example, the user interface includes a reference image 1110 and a video frame 1120. In some examples, a user may click at a reference image location 1112 and a video frame location 1122, such that the reference image location 1112 is corresponding to the video frame location 1122. In certain embodiments, the video player may receive other user inputs to identify an image location, such as a double-click, a drawing, and/or the like.

According to certain embodiments, the georegistration system 105 and/or the video player 140 receives one or more pairs of video frame locations and reference image locations. In some embodiments, the georegistration system 105 and/or the video player 140 determines geospatial coordinates 144 associated with the video frame 112 based on the one or more reference image locations, for example, setting the geospatial coordinates 144 as geospatial coordinates corresponding to the reference image locations. In some embodiments, the georegistration system 105 and/or the video player 140 passes the geospatial coordinates 144 to SIP 120. In certain embodiments, the georegistration system 105 and/or the SIP 120 determines the geospatial coordinates 124 based on the geospatial coordinates 144 and sends and/or passes the geospatial coordinates 144 to the georegistration processor 130. In some embodiments, the geospatial coordinates 124 are set to the same as the geospatial coordinates 144.

In certain embodiments, in response to the user 150 clicking on an image location in the reference image, the georegistration system 105 identifies a corresponding frame location in the video frame 112. In some embodiments, in response to the user 150 clicking on a pixel or a target of interest in the video frame 112, the georegistration system 105 identifies a corresponding frame location in the video frame 112 via object recognition and generates a pair of video frame location and reference image location. In certain embodiments, in response to the user 150 clicking on a pixel or a target of interest in the video frame 112, the georegistration system 105 identifies a corresponding spot in the reference image. In some embodiments, in response to the user 150 clicking on a pixel or a target of interest in the video frame 112, the georegistration system 105 identifies a corresponding spot in the reference image via object recognition and generates a pair of video frame location and reference image location. In certain embodiments, the georegistration system 105 and/or the video player 140 receive one or more pairs of video frame locations and reference image locations.

In certain embodiments, the georegistration system 105 and/or the georegistration processor 130 uses a pair of points (e.g., a first pair of points, a pair of video frame location and reference image location) to determine a geographic location (e.g., coordinates) of the video frame, for example, these two are the same locations. In some examples, the video frame 112 lacks the telemetry data indicating and/or corresponding to how big is the viewing area, and/or the like. In certain embodiments, the georegistration system 105 and/or the georegistration processor 130 uses a pair of points (e.g., a second pair of points) to determine the rotation between the video frame and the reference image.

In certain embodiments, the georegistration system 105 and/or the georegistration processor 130 uses a pair of points (e.g., a third pair of points) to determine the scale and/or the aspect ratio between the video frame and the reference image. In some embodiments, the georegistration system 105 and/or the georegistration processor 130 uses a pair of points (e.g., a third pair of points) to determine a scale function and/or an aspect ratio function between the video frame and the reference image. In certain embodiments, there is still ambiguity, for example, between basically a large field of view camera close up or a small field of view camera farther away. In some embodiments, the georegistration system 105 and/or the georegistration processor 130 uses a pair of points (e.g., a fourth pair of points) to help solve ambiguity of the previous computations. In some embodiments, the georegistration system 105 and/or the georegistration processor 130 uses a pair of points (e.g., a fourth pair of points) to modify the location data, the rotation function, the scale function, and/or the aspect ratio function. In certain embodiments, the georegistration system 105 and/or the georegistration processor 130 uses additional pair of points to generate an image transformation to reach greater mathematical accuracy.

According to certain embodiments, the georegistration system 105 and/or the georegistration processor 130 uses one or more solutions for Perspective-n-Point (PnP) problems to generate telemetry data (e.g., position, pointing, etc.) associated with the image sensor and/or the video frame, for example, a PnP solver, an efficient PnP (EPnP) solver, a SQPnP (sequential quadratic PnP) solver, a RANSAC (random sample consensus) method, and/or the like.

According to some embodiments, the georegistration processor 130 uses the geospatial coordinates 124 to perform georegistrations, also referred to user interactive georegistrations or user-centered georegistrations, and generate georegistration results 136. In some embodiments, the georegistration processor 130 generates telemetry data associated with the image sensor and/or the video frame based on the geospatial coordinates 124. In some embodiments, the georegistration processor 130 generates georegistration results 136 based at least in part on the generated telemetry data, received telemetry data (if any) and reference images. In certain embodiments, the georegistration processor 130 transmits the georegistration results 136 to the SIP 120.

In some embodiments, the georegistration system 105 and/or the SIP 120 combines the georegistration results 130 with the video frames 112 and generates registered frames 126, also referred to as georegistered frames. In certain embodiments, the SIP 120 sends the registered frames 126 to the video player 140. In some embodiments, the video player 140 presents the registered frames 146 to the user 150.

According to certain embodiments, when receiving a user input (e.g., a user clicks on the user interface), the georegistration system 105 and/or the video player 140 initiates the user interactive georegistration workflow, for example, for a user interactive session. In some embodiments, the video player 140 pauses on the video frame 112 and record the corresponding timestamp. In certain embodiments, the video player 140 passes the pairs of points and the timestamp to the georegistration processor 130, for example, via the SIP 120. In some embodiments, the georegistration system 105 and/or the georegistration processor 130 keeps a historical cache of frames, for example, the last one minute of video frames. In certain embodiments, the georegistration system 105 and/or the georegistration processor 130 obtains and/or extracts the video frame from the historical cache based on the timestamp.

In some embodiments, the georegistration environment or workflow 100 includes a repository (not shown) can include and/or store videos, video frames, metadata, geolocation information, reference imagery (e.g., maps), georegistration transforms, image-based transforms, and/or the like. The repository may be implemented using any one of the configurations described below. A data repository may include random access memories, flat files, XML files, and/or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components in the georegistration environment 100 can execute software or firmware stored in non-transitory computer-readable medium to implement various processing steps. Various components and processors of the georegistration environment 100 can be implemented by one or more computing devices including, but not limited to, circuits, a computer, a cloud-based processing unit, a processor, a processing unit, a microprocessor, a mobile computing device, and/or a tablet computer. In some cases, various components of the georegistration environment 100 (e.g., the georegistration system 105, the one or more georegistration processors 130, the one or more SIPs 120, one or more the video players 140, etc.) can be implemented on a shared computing device. Alternatively, a component of the georegistration environment 100 can be implemented on multiple computing devices. In some implementations, various modules and components of the georegistration environment or workflow 100 can be implemented as software, hardware, firmware, or a combination thereof. In some cases, various components of the georegistration environment or workflow 100 can be implemented in software or firmware executed by a computing device.

Various components of the georegistration environment or workflow 100 can communicate via or be coupled to via a communication interface, for example, a wired or wireless interface. The communication interface includes, but is not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBeeR or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

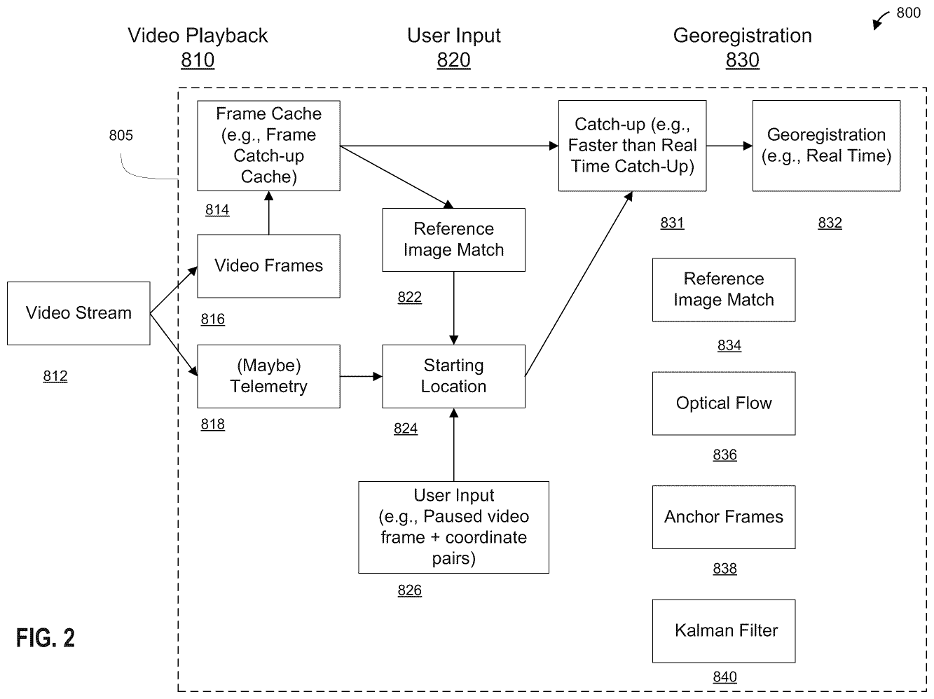

FIG. 2 is an illustrative diagram for a software architecture and workflow 800 for a georegistration system, according to certain embodiments of the present application. FIG. 2 is merely an example. One of the ordinary skilled in the art would recognize many variations, alternatives, and modifications. The software architecture and workflow 800 for the georegistration system includes components and processes 810, 812, 814, 816, 818, 820, 822, 824, 826, 830, 832, 832, 834, 836, 838, and 840. Although the above has been shown using a selected group of components and processes for the software architecture 200 for the video georegistration system, there can be many alternatives, modifications, and variations. For example, some of the components and/or processes may be expanded and/or combined. Other components and/or processes may be inserted into those noted above. Depending upon the embodiment, the sequence of processes may be interchanged with others replaced. Further details of these components and processes are found throughout the present disclosure.

According to certain embodiments, the software architecture and workflow 800 includes a video section 810, a user input section 820, and a georegistration section 830. In certain embodiments, the georegistration system 805 receives a video stream 810 (e.g., a video stream with a frame rate of 30 frames-per-second (FPS), a video stream with a frame rate of 60 FPS, etc.). In some embodiments, the video stream 810 is captured by an image sensor. In certain embodiments, the video stream 810 is captured by one or more image sensors. In some embodiments, the video stream 812 includes one or more video frames 816 and telemetry data 818. In certain embodiments, the telemetry data includes or is metadata of the video stream. In some embodiments, the telemetry data includes location data and image sensor information. In certain embodiments, the telemetry data includes image sensor characteristics and/or location and movement characteristics associated with the image sensor. In some embodiments, the image sensor characteristics include, for example, a pointing angle, a focal length, and/or the like. In certain embodiments, the telemetry data includes geospatial coordinates, image sensor pointing angle (e.g., viewing angle), sensor zooming data, and/or the like. In some embodiments, the telemetry data is partial telemetry data, or referred to as incomplete telemetry data, where some telemetry data is missing and/or unreliable. For example, the telemetry data includes location data but not the sensor pointing information.

According to some embodiments, incomplete telemetry data is not sufficient for the conventional georegistration technique for georegistration to be conducted accurately and/or reliably. In certain embodiments, the georegistration system 805 is waiting for and monitoring user inputs 826. In some embodiments, the georegistration system 805 includes a frame cache 814 (e.g., a frame catch-up cache, a frame repository), which includes video frames for a period of time, for example, frames of the past minute. In certain embodiments, the frame catch-up cache 814 includes video frames for a predetermined period of time. In some embodiments, the frame catch-up cache 814 includes video frames that is continuously refreshing.

According to certain embodiments, the georegistration system 805 receives one or more user inputs 826 (e.g., coordinate pairs). In some embodiments, the georegistration system 805 pauses the video frame when receiving a first user interaction (e.g., a click). In some embodiments, the georegistration system 805 determines the position, angle, and/or scale associated with the image sensor and/or the video frame based on the user inputs 826. In certain embodiments, the georegistration system 805 determines a starting location 824 from those data. In some embodiments, the georegistration system 805 uses reference image match 822 to improve the accuracy of the starting location 824. In certain embodiments, the georegistration system 805 determines the incomplete telemetry data (e.g., missing telemetry data, unreliable telemetry data, etc.) associated with the first video frame based at least in part on the one or more determined coordinates. In some embodiments, the incomplete telemetry data includes a pointing angle (e.g., a pose) of an image sensor, a scale (e.g., a focal length) of an image sensor, a heading of a movement of an image sensor (e.g., a carrier of an image sensor), an orientation of a movement of an image sensor, and/or the like.

According to certain embodiments, the georegistration system 805 determines the incomplete telemetry data including at least one selected from a group consisting of a geospatial coordinate associated with the first video frame, a pointing angle of the image sensor, and a focal length of the image sensor. In certain examples, finding the sensor position and pointing from the four pairs of user input points is an instance of a Perspective-n-Point (PnP) problem. In some embodiments, the georegistration system 805 can use one or more techniques for PnP. In certain embodiments, the georegistration system 805 uses one or more solutions for PnP to generate telemetry data (e.g., position, pointing, pose etc.), for example, a PnP solver, a P3P solver, an efficient PnP (EPnP) solver, a SQPnP (sequential quadratic PnP) solver, an IPPE (infinitesimal plane-based pose estimation) method, a RANSAC (random sample consensus) method, and/or the like. In some embodiments, a pose of an image sensor (e.g., a camera) corresponds to six degrees of freedom.

In certain examples, the georegistration system uses SQPnP technique. In some embodiments, a PnP technique may require a known field of view; focal length, and/or the like. In certain embodiments, if the telemetry data 818 lacks field of view, the system performs a search of the space of plausible field of view values and chooses a field of view, for example, a result with the lowest error. In some embodiments, the telemetry data 818 includes a field of view value, which makes the process more accurate and slightly faster. In certain embodiments, if other partial telemetry values are available and reliable, they can be used to solve the sensor position and/or pointing. In certain embodiments, the partial telemetry values can be used to provide constraints for the sensor position and/or pointing.

According to some embodiments, the image sensor captures the video stream from an aerial location. In certain embodiments, the starting location 824 for the image sensor is associated with the image sensor's azimuth, elevation, and roll. In some embodiments, the starting location 824 for the image sensor includes at least one selected from a group consisting of azimuth, elevation, and roll. In certain embodiments, the starting location for the image sensor includes azimuth, elevation, and roll. In some examples, the starting location 824 includes the direction that the sensor is pointing as well as the field of view: In certain embodiments, the starting location 824 includes a set of data describing how to project from the image sensor (e.g., a camera) to the ground.

According to certain embodiments, after the starting location is determined, the georegistration system 805 includes a catch-up video layer 832 (e.g., faster than real-time catch-up), because it takes some time to gather the user input 826. In some embodiments, the catch-up video layer 832 plays frames from a cache of frames (e.g., the frame cache 814) instead of just taking new frames as the new video frames 816 come.

According to some embodiments, the georegistration system 805 implements a georegistration process 832, a reference image match process 834, an optical flow 836, an anchor frame match process 838, and a Kalman filter 840. According to certain embodiments, the georegistration processor 832 includes a calibration module (e.g., a calibration processor) to perform calibration to video frames at a selected FPS. In some embodiments, the calibration module can perform calibration to video frames at full FPS, for example, each video frame is calibrated. In certain embodiments, the calibration module uses historical telemetry data (e.g., past telemetry) and/or any corrections (e.g., baked-in corrections). In some embodiments, the calibration module requires lightweight computational cost (e.g., a few milliseconds, a couple of milliseconds).

According to some embodiments, the optical flow process 130 includes processing video frames 816 at a low FPS (e.g., 5 FPS, adaptive FPS). In certain embodiments, the georegistration system 805 computes an optical-flow-based motion model to provide an alternative, smoothed estimate of the motion of one or more objects in the video. In some embodiments, depending on performance profiles, the georegistration system 805 moves the computational kernel for the optical flow process 836 into a specific library (e.g., a C++ library). In certain embodiments, the georegistration system 805 and/or the optical flow process 836 uses DEM (digital elevation model) or similar data model (e.g., digital terrain model) to translate visual motion to estimated physical motion. In some embodiments, the optical flow process 836 requires middleweight computational cost (e.g., tens of milliseconds or more). In certain embodiments, the optical flow process 836 extracts relative motions of objects from video frames 816 to make corrections.

According to certain embodiments, the georegistration system 805 performs reference image match process 834, for example, to generate a georegistration transform, also referred to as an image transform, based at least in part on the reference image. In some embodiments, matched reference images cannot be found, for example, because an aircraft (e.g., a small UAS) is lower to the ground. In certain embodiments, the georegistration system 805 is configured to generate reliable georegistration results without the matched reference image being found. In some embodiments, the reference image match process 834 can use scale-invariant feature transform (SIFT) algorithm.

According to some embodiments, the Kalman filter 840 can be designed specifically for the georegistration system. In certain embodiments, the Kalman filter 840 includes outputs of geospatial coordinates on the ground, for example, for the georegistration system 805 tracking ground objects. In some examples for a georegistration system used for a video stream collected by an UAS, the image sensor on the UAS does not change its viewing angle, and the Kalman filter 840 is designed to incorporate such features. In some embodiments, the georegistration system 805 uses a first Kalman filter 840 for a first video stream 812 captured by a first image sensor on a large UAS and a second Kalman filter 840 for a second video stream 812 captured by a second image sensor on a small UAS, where the first Kalman filter 840 is different from the second Kalman filter 840.

In certain embodiments, the Kalman filter 840 includes a Bayesian state estimation technique that combines a prediction of how a given process behaves and a measurement of the current state. In some embodiments, the usage of the prediction and the measurement improves accuracy in the final state estimate, for example, compared with other techniques. In certain embodiments, an unscented Kalman filter is an extension of a Kalman filter that is configured to handle non-linearity.

According to certain embodiments, the georegistration system 805 includes an anchor frame match process 838 using an anchor frame repository, for example, a database of selected video frames. In some embodiments, the anchor frames include video frames with which a user interacts, also referred to as initial frames. In certain embodiments, additional anchor frames are identified, for example, a video frame a certain amount from the initial frame, a video frame associated with different image characteristics (e.g., zooming, rotating, etc.) and/or different sensor characteristics (e.g., focal length, pointing information). In some embodiments, the use of anchor frames can reduce drifting over time.

In certain embodiments, if the georegistration system 805 determines that the georegistration of the current video frame is unreliable, (e.g., a dramatic motion, a dramatic change in zoom), the georegistration system 805 and/or the anchor frame match process 838 can identify a matched anchor frame to the current video frame for georegistration. In some embodiments, the georegistration system 805 can use the georegistration and/or the geospatial coordinates of the identified anchor frame to determine the georegistration for the current video frame. In certain embodiments, the anchor frame match process 838 uses a SIFT algorithm.

According to some embodiments, the georegistration system 805 is configured to track the video stream 810 at a first frame rate (e.g., full frame rate), perform the optical flow process 836 at a second frame rate, perform the anchor frame match process 838 at a third frame rate, perform reference image match process 832 at a fourth frame rate. In certain embodiments, the second frame rate (e.g., every 3 frames) is lower than the first frame rate (e.g., every frame). In some embodiments, the third frame rate (e.g., every 30 frames) is lower than the second frame rate (e.g., every 3 frames). In some embodiments, the fourth frame rate (e.g., every 10 frames) is lower than the second frame rate (e.g., every 3 frames).

According to certain embodiments, the georegistration system 805 initializes and/or configures the reference image (e.g., a base map) based on prior location information and/or prior user input. In some embodiments, the georegistration system 805 takes the user input with a single-click to the reference image or a video frame. In certain embodiments, the georegistration system 805 uses partial telemetry data associated with the video frame to constraint the reference image (e.g., the track space), and/or to initially solve the starting location 824, such as determining a part of the missing telemetry data (e.g., a pointing angle, a scale, a field of view, etc.).

According to some embodiments, the georegistration system 805 can perform georegistration for low quality or missing reference imagery. In certain embodiments, the georegistration system 805 can be used for visual navigation to track one or more objects. In some embodiments, the georegistration system 805 can be used to correct conventional georegistration based on user inputs 826, if the user inputs are more accurate. In certain embodiments, the georegistration system 805 can be used for target-only tracking, where there is no telemetry and the image sensor conducts active tracking of the target. In some examples, the georegistration system 805 tracks a plurality of image locations (e.g., corners, four corners) and/or a bounding box of a target area.

According to certain embodiments, the georegistration system 805 is configured to load one or more anchor frames and use the anchor frames during the georegistration process. In some embodiments, the georegistration system 805 uses a machine learning model to generate an image segmentation (e.g., an automatic image segmentation), such as a geometry of a target of interest from a single click. In certain embodiments, the machine learning model is applied to the video frame to identify the target of interest and a bounding box and/or a plurality of image locations associated with the target of interest. In some embodiments, the georegistration system 85 uses the plurality of image locations and/or the bounding box for georegistration.

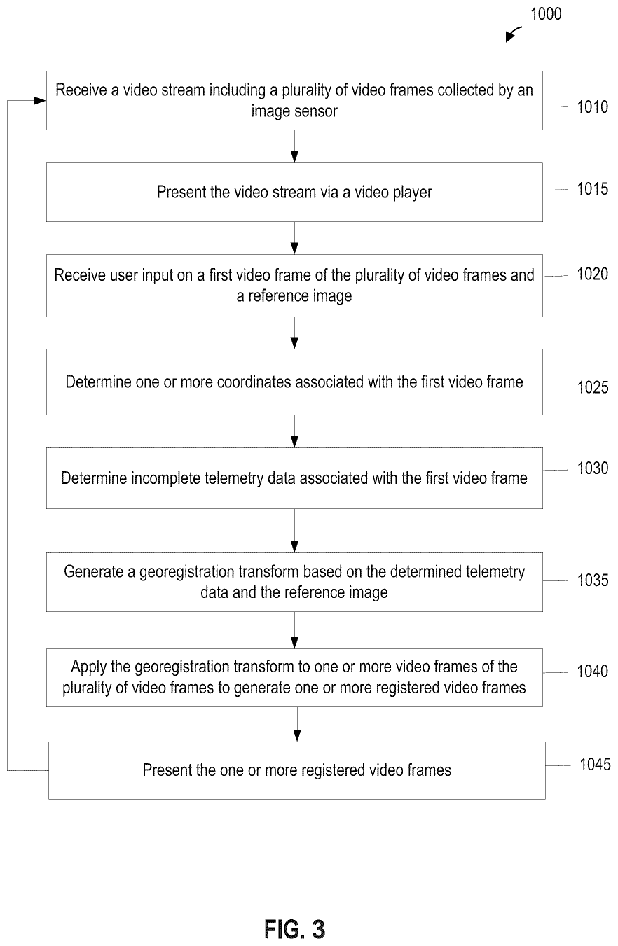

FIG. 3 is a simplified diagram showing a method 1000 for georegistration according to certain embodiments of the present disclosure. This diagram is merely an example. One of ordinary skill in the art would recognize many variations, alternatives, and modifications. The method 1000 for georegistration includes processes 1010, 1015, 1020, 1025, 1030, 1035, 1040, and 1045. Although the above has been shown using a selected group of processes for the method 1000 for georegistration, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

In some embodiments, some or all processes (e.g., steps) of the method 1000 are performed by a system (e.g., the computing system 600). In certain examples, some or all processes (e.g., steps) of the method 1000 are performed by a computer and/or a processor directed by a code. For example, a computer includes a server computer and/or a client computer (e.g., a personal computer). In some examples, some or all processes (e.g., steps) of the method 1000 are performed according to instructions included by a non-transitory computer-readable medium (e.g., in a computer program product, such as a computer-readable flash drive). For example, a non-transitory computer-readable medium is readable by a computer including a server computer and/or a client computer (e.g., a personal computer, and/or a server rack). As an example, instructions included by a non-transitory computer-readable medium are executed by a processor including a processor of a server computer and/or a processor of a client computer (e.g., a personal computer, and/or server rack).

According to some embodiments, at process 1010, the system receives a video stream including a plurality of video frames collected by an image sensor. In certain embodiments, the video stream and/or one or more video frames in the plurality of video frames miss some telemetry data and/or are associated with some unreliable telemetry data. In some embodiments, the video stream and/or one or more video frames in the plurality of video frames have incomplete telemetry data.

According to certain embodiments, at process 1015, the system presents the video stream via a video player (e.g., a video player integrated with a computing device). In some embodiments, at process 1020, the system receives user input on a first video frame of the plurality of video frames and a reference image from a user. In certain embodiments, the reference image is a map. In certain embodiments, the system pauses the video stream when the user input is received. In some embodiments, the user input includes a first frame location on the first video frame and a first image location on the reference image. In certain embodiments, the first frame location is received based on a click on the first video frame. In some embodiments, the first image location is received based on a click on the reference image. In certain embodiments, the first image location is determined by a computational model (e.g., a machine learning model) based on the first frame location and the reference image. In some embodiments, the first frame location is determined by a computational model (e.g., a machine learning model) based on the first image location and the first video frame.

According to some embodiments, the user input includes a plurality of pairs of user inputs to the first video frame and the reference image, wherein each pair of user inputs includes a user input to the first video frame and a user input to the reference image. In certain embodiments, the plurality of pairs of user inputs includes three or more pairs of user inputs.

According to certain embodiments, at process 1025, the system determines one or more coordinates associated with the first video frame. In some embodiments, the one or more coordinates are one or more geospatial coordinates associated with one or more frame locations in the first video frame. In certain embodiments, the system identifies one or more geospatial coordinates associated with the reference image and determines one or more geospatial coordinates associated with the one or more frame locations based on the one or more geospatial coordinates associated with the reference image. In some embodiments, the user input is received via a prompt. In certain embodiments, the system extracts a description from the prompt using a large language model (LLM). In some embodiments, the system determines a frame location in the video frame and/or an image location in the reference image based on the extracted description.

According to some embodiments, at process 1030, the system determines telemetry data associated with the first video frame. In certain embodiments, the system determines the incomplete telemetry data (e.g., missing telemetry data, unreliable telemetry data, etc.) associated with the first video frame based at least in part on the one or more determined coordinates. In some embodiments, the incomplete telemetry data includes a pointing angle (e.g., a pose) of an image sensor, a scale (e.g., a focal length) of an image sensor, a heading of a movement of an image sensor (e.g., a carrier of an image sensor), an orientation of a movement of an image sensor, and/or the like.

According to certain embodiments, the system determines the incomplete telemetry data including at least one selected from a group consisting of a geospatial coordinate associated with the first video frame, a pointing angle of the image sensor, and a focal length of the image sensor. In certain embodiments, the system uses a PnP solver (e.g., an SQPnP solver) to determine the incomplete telemetry data based on the plurality of pairs of user inputs. In certain embodiments, the system uses a PnP solver (e.g., an SQPnP solver) to determine the incomplete telemetry data based on the plurality of pairs of geolocation coordinates associated with the first video frame and the reference image.

According to certain embodiments, at process 1035, the system generates a georegistration transform based on the determined telemetry data and the reference image. In some embodiments, at process 1040, the system applies the georegistration transform to one or more video frames of the plurality of video frames to generate one or more registered video frames. In certain embodiments, at process 1045, the system presents the one or more registered video frames via the video player.

According to some embodiments, the georegistration process is iterative. In certain embodiments, the system conducts georegistration process at a fixed frame rate or at a dynamic frame rate. In some embodiments, the system identifies one or more anchor frames including one or more video frames that have associated user inputs. In certain embodiments, the system identifies an anchor frame as a second video frame associated with the first video frame and determines a second georegistration transform based at least in part on the anchor frame.

According to certain embodiments, the system identifies an anchor frame by determining the anchor frame meeting one or more selection criteria. In some embodiments, the one or more section criteria comprises at least one selected from a group consisting of a criterion on a number of frames between the first video frame and the second video frame, a criterion on a difference between a second sensor characteristic associated with the second video frame and a first sensor characteristic associated with the first video frame. In certain examples, when the georegistration for a video frame is unreliable, the system finds a matching anchor frame and uses the georegistration transform and/or the geospatial coordinates associated with the anchor frame for the video frame.

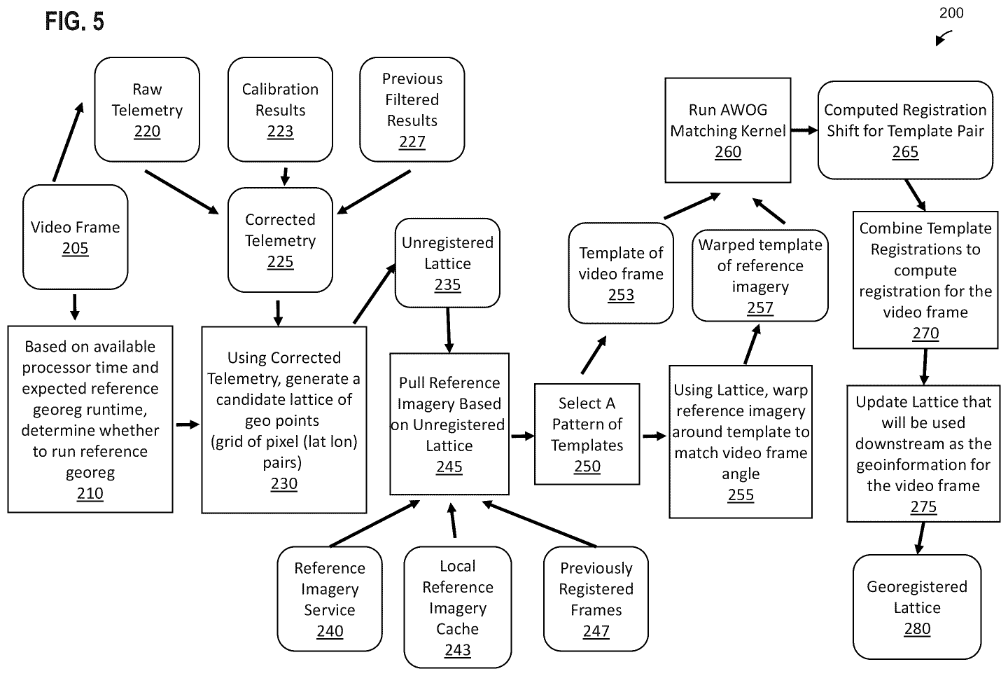

FIG. 5 is a simplified diagram showing a software architecture 200 for a video georegistration system according to certain embodiments of the present disclosure. This diagram is merely an example. One of ordinary skill in the art would recognize many variations, alternatives, and modifications. The architecture 200 for the video georegistration system includes components and processes 210, 220, 223, 225, 227, 230, 235, 240, 243, 245, 247, 250, 253, 255, 257, 260, 265, 270, 275 and 280. Although the above has been shown using a selected group of components and processes for the software architecture 200 for the video georegistration system, there can be many alternatives, modifications, and variations. For example, some of the components and/or processes may be expanded and/or combined. Other components and/or processes may be inserted into those noted above. Depending upon the embodiment, the sequence of processes may be interchanged with others replaced. Further details of these components and processes are found throughout the present disclosure.

According to some embodiments, the video georegistration system receives one or more videos or video streams including one or more video frames 205 (e.g., 30 frames-per-second (FPS), 60 FPS, etc.). In certain embodiments, at process 210, the video georegistration system is configured to determine whether to run reference georegistration based on available processor time and expected reference georegistration runtime. In some embodiments, if the available processor time is lower than the expected reference georegistration runtime, the video georegistration system does not perform the reference georegistration. In certain embodiments, if the available processor time is greater than the expected reference georegistration runtime, the video georegistration system continues to perform the reference georegistration.

According to certain embodiments, the video georegistration system generates corrected telemetry 225 based on raw telemetry 220, calibrated results 223, and/or previous filtered results (e.g., Kalman filter aggregated results) 227. In some embodiments, the raw telemetry 220 is extracted from the received video, the video stream and/or a video frame of the one or more video frames 205. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results 227. In certain embodiments, the calibration can correct some types of video feed exhibit systematic errors. In some examples, the systematic errors include an error in the field of view (e.g., the lens angle). For example, a lens angle of 5.1 degrees is actually 5.25 degrees, and such deviation can be used in calibration.

According to some embodiments, at the process 230, the video georegistration system generates a candidate lattice of geo points (e.g., grid of pixel (latitude, longitude) pairs) using corrected telemetry and generates unregistered lattice 235. In certain embodiments, at the process 245, the video georegistration system is configured to pull reference imagery based on unregistered lattice. In some embodiments, the video georegistration system uses reference imagery service 240, local reference imagery cache 243, and/or previously registered frames 247 to pull reference imagery. In certain embodiments, the video georegistration system can retrieve or generate reference imagery synchronously (e.g., within one hour) with the input video, for example, using the reference imagery service 240. In some embodiments, the video georegistration system can use local reference imagery cache 243 to retrieve reference imagery. In certain embodiments, the video georegistration system can use previously registered frames 247 (e.g., reference image used in previously registered frames).

According to certain embodiments, the reference imagery (e.g., reference image) can be generated based upon the geo-coordinates of the unregistered lattice. In some embodiments, the reference imagery is retrieved from the local reference imagery cache 243, for example, at the same edge device on which at least a part of the video georegistration system is running. In certain embodiments, the reference imagery is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple a platform (e.g., a platform that harnesses satellite technology for autonomous decision making) with other available sources of satellite imagery to automatically pull the satellite images of an area (e.g., an area associated with the input video, an area associated with the video frame, an area associated with the unregistered lattice) and automatically build a base map in that area proximate in time (e.g., within four (4) hours, within one hour).

According to certain embodiments, at the process 250, the video georegistration system selects a pattern of templates and generates a template (e.g., a template slice) of the video frame 253. In some embodiments, at the process 255, the video georegistration system warps reference imagery around a template to match the video frame angle to generate a warped template (e.g., template slice) of reference imagery 257. In certain embodiments, at the process 260, the video georegistration system runs AWOG matching and/or other matching algorithm to the template and the warped template, also referred to as the template pair, to generates the computed registration shift for the template pair 265.

According to some embodiments, the video georegistration system recursively generates registrations for the templates. In certain embodiments, at the process 270, the video georegistration system combines template registrations to generate a frame registration (e.g., an image transform) for the video frame. In some embodiments, at the process 275, the video georegistration system updates the lattice using the frame registration to generate the georegistered lattice 280, which can be used downstream as the geoinformation for the video frame. In certain embodiments, the video georegistration system can use the frame registration to generate the georegistered video frame.

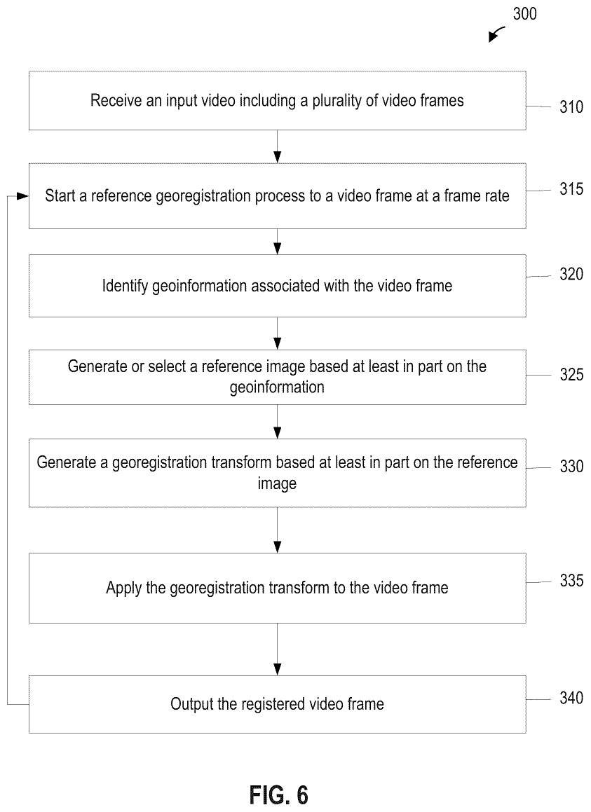

FIG. 6 is a simplified diagram showing a method 300 for video georegistration according to certain embodiments of the present disclosure. This diagram is merely an example. One of ordinary skill in the art would recognize many variations, alternatives, and modifications. The method 300 for sorting templates and/or generating a template queue includes processes 310, 315, 320, 325, 330, 335, and 340. Although the above has been shown using a selected group of processes for the method 300 for sorting templates and/or generating a template queue, there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to certain embodiments, at the process 310, the georegistration system receives an input video including a plurality of video frames. In certain embodiments, at the process 315, the video georegistration system is configured to start a reference georegistration process to a video frame at a frame rate. In some embodiments, the frame rate is a fixed frame rate. In certain embodiments, the frame rate is a dynamic frame rate (e.g., not a fixed frame rate). In some embodiments, the video georegistration system determines whether to run reference georegistration based on available processor time and expected reference georegistration runtime. In some embodiments, if the available processor time is lower than the expected reference georegistration runtime, the video georegistration system does not perform the reference georegistration. In certain embodiments, if the available processor time is greater than the expected reference georegistration runtime, the video georegistration system continues to perform the reference georegistration.

According to certain embodiments, at the process 320, the video georegistration system identifies geoinformation associated with the video frame. In some embodiments, the video georegistration system generates corrected telemetry based on raw telemetry, calibrated results, and/or previous filtered results (e.g., Kalman filtered results). In some embodiments, the raw telemetry is extracted from the received video, the video stream and/or a video frame of the one or more video frames. In certain embodiments, the calibration is to essentially clean up the video telemetry on the basis of common failure modes. In some embodiments, the calibration includes interpolating missing frames of the telemetry. In certain embodiments, the calibration includes lining up the video frames in case they came in staggered. In some embodiments, the calibration includes the ability to incorporate basically known corrections, such as previous filtered results. In certain embodiments, the calibration can correct some types of video feed exhibit systematic errors.

According to some embodiments, the video georegistration system generates a candidate lattice of geo points (e.g., grid of pixel (latitude, longitude) pairs) using corrected telemetry and generates unregistered lattice. In certain embodiments, at the process 325, the video georegistration system is configured to generate or select a reference image based at least in part on the geoinformation associated with the video frame (e.g., unregistered lattice). In some embodiments, the video georegistration system uses reference imagery service, local reference imagery cache, and/or previously registered frames to pull reference imagery. In certain embodiments, the video georegistration system can retrieve or generate reference imagery synchronously (e.g., within one hour) with the input video, for example, using the reference imagery service. In some embodiments, the video georegistration system can use local reference imagery cache to retrieve reference imagery. In certain embodiments, the video georegistration system can use previously registered frames (e.g., reference imagery used in previously registered frames). In some embodiments, the video georegistration system can combine multiple images to generate the reference image.

According to certain embodiments, the reference image can be generated based upon the geo-coordinates of the unregistered lattice. In some embodiments, the reference imagery is retrieved from the local reference imagery cache, for example, at the same edge device on which at least a part of the video georegistration system is running. In certain embodiments, the reference image is generated, stored, and/or retrieved from the same edge environment (e.g., on the physical plane). In some embodiments, the georegistration system avoids sending out requests for using, on high-latency connection. In certain embodiments, the georegistration system can use a pre-bundle set of tiles or shifted pre-bundle set of tiles as the reference imagery. In some embodiments, the georegistration system and/or another system support the generation (e.g., rapid generation) of localized base maps for reference imagery creation.

According to some embodiments, the georegistration system can couple with a meta-constellation platform with other available sources of satellite imagery to automatically pull the satellite images of an area (e.g., an area associated with the input vide, an area associated with the video frame, an area associated with the unregistered lattice) and automatically build a base map in that area proximate in time (e.g., within four (4) hours, within one hour).

According to certain embodiments, at the process 330, the video georegistration system generates a georegistration transform based at least in part on the reference image. In some embodiments, the video georegistration system selects a pattern of templates and generates a template (e.g., a template slice) of the video frame. In some embodiments, the video georegistration system warps reference imagery around a template to match the video frame angle to generate a warped template (e.g., template slice) of reference imagery. In certain embodiments, the video georegistration system runs AWOG matching and/or other matching algorithm to the template and the warped template, also referred to as the template pair, to generates the computed registration shift for the template pair.

According to some embodiments, the video georegistration system recursively generates registrations for the templates. In certain embodiments, the video georegistration system combines template registrations to generate a frame registration (e.g., an image transform) for the video frame. In some embodiments, the video georegistration system updates the lattice using the frame registration to generate the georegistered lattice, which can be used downstream as the geoinformation for the video frame.

According to certain embodiments, at the process 335, the video georegistration system applies the georegistration transform to the video frame to generate the registered video frame (e.g., the georegistered video frame). In some embodiments, at the process 340, the video georegistration system outputs the registered video frame. In certain embodiments, the video georegistration system recursively conducts steps 315-340 to continuously generate georegistered video frames and/or georegistered videos.

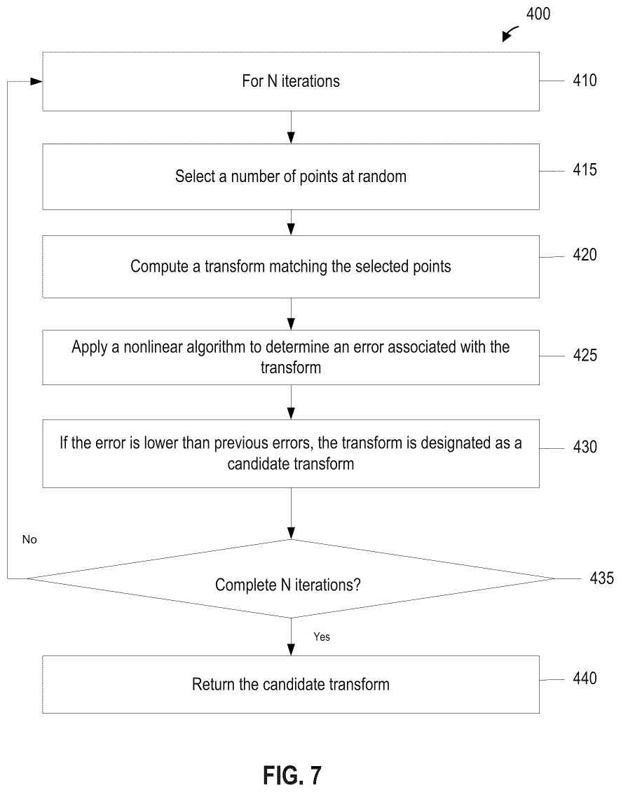

FIG. 7 is a simplified diagram showing a method 400 for generating a transformation (e.g., an image transformation) according to certain embodiments of the present disclosure. This diagram is merely an example. One of ordinary skill in the art would recognize many variations, alternatives, and modifications. The method 400 for generating a transformation (e.g., an image transformation) includes processes 410, 415, 420, 425, 430, 435, and 440. Although the above has been shown using a selected group of processes for the method 400 for generating a transformation (e.g., an image transformation), there can be many alternatives, modifications, and variations. For example, some of the processes may be expanded and/or combined. Other processes may be inserted into those noted above. Depending upon the embodiment, the sequence of processes may be interchanged with others replaced. Further details of these processes are found throughout the present disclosure.

According to certain embodiments, at the process 410, the georegistration system conducts image transformation computation for N iterations. In some embodiments, the georegistration system conducts image transformation computation with iterations. In certain embodiments, at the process 415, the georegistration system selects a number of points (e.g., 3 points) at random, at the process 420, the georegistration system computes a transform matching the selected points. In some embodiments, the georegistration system selects a predetermined number of points at random and computes the transform (e.g., affine transform) matching those selected points. In certain embodiments, the georegistration system selects one point for a translation.

According to some embodiments, at the process 425, the georegistration system applies a nonlinear algorithm (e.g., a Levenberg-Marquardt nonlinear algorithm) to determine an error associated with the transform. In certain embodiments, the georegistration system applies the nonlinear algorithm to the sum of the distances (e.g., Lorentz distances) between every point's shift value (e.g., preferred shift value). In certain embodiments, each point's shift value is weighted by each point's strength value in determining the error.

According to certain embodiments, at the process 430, if the error is lower than all previous transform, the transform is designated as a candidate transform (e.g., best candidate). In some embodiments, at the process 435, the georegistration system determines whether the N iterations have been completed. In certain embodiments, the georegistration system goes back to the process 410 if the N iterations have not been completed. In some embodiments, the georegistration system goes to the process 440 if the N iterations have been completed. In certain embodiments, at the process 440, the georegistration system returns the candidate transform (e.g., the best candidate transform).

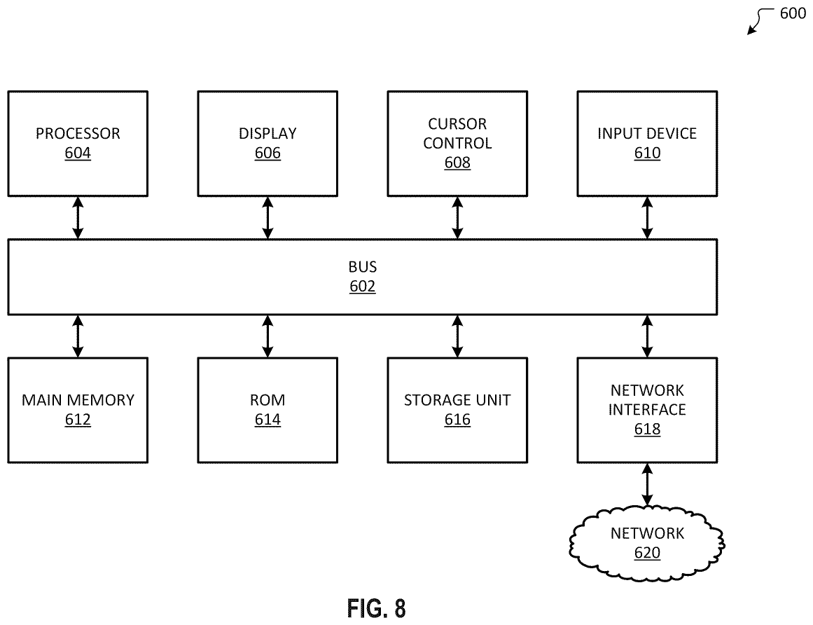

FIG. 8 is a simplified diagram showing a computing system for implementing a system 600 for georegistration in accordance with at least one example set forth in the disclosure. This diagram is merely an example, which should not unduly limit the scope of the claims. One of ordinary skill in the art would recognize many variations, alternatives, and modifications.

The computing system 600 includes a bus 602 or other communication mechanism for communicating information, a processor 604, a display 606, a cursor control component 608, an input device 610, a main memory 612, a read only memory (ROM) 614, a storage unit 616, and a network interface 618. In some embodiments, some or all processes (e.g., steps) of the methods 1000, 300, and/or 400 are performed by the computing system 600. In some examples, the bus 602 is coupled to the processor 604, the display 606, the cursor control component 608, the input device 610, the main memory 612, the read only memory (ROM) 614, the storage unit 616, and/or the network interface 618. In certain examples, the network interface is coupled to a network 620. For example, the processor 604 includes one or more general purpose microprocessors. In some examples, the main memory 612 (e.g., random access memory (RAM), cache and/or other dynamic storage devices) is configured to store information and instructions to be executed by the processor 604. In certain examples, the main memory 612 is configured to store temporary variables or other intermediate information during execution of instructions to be executed by processor 604. For examples, the instructions, when stored in the storage unit 616 accessible to processor 604, render the computing system 600 into a special-purpose machine that is customized to perform the operations specified in the instructions. In some examples, the ROM 614 is configured to store static information and instructions for the processor 604. In certain examples, the storage unit 616 (e.g., a magnetic disk, optical disk, or flash drive) is configured to store information and instructions.

In some embodiments, the display 606 (e.g., a cathode ray tube (CRT), an LCD display, or a touch screen) is configured to display information to a user of the computing system 600. In some examples, the input device 610 (e.g., alphanumeric and other keys) is configured to communicate information and commands to the processor 604. For example, the cursor control component 608 (e.g., a mouse, a trackball, or cursor direction keys) is configured to communicate additional information and commands (e.g., to control cursor movements on the display 606) to the processor 604.

According to certain embodiments, a method for georegistration is provided. In some embodiments, the method includes: receiving a video stream including a plurality of video frames collected by an image sensor: presenting the video stream via a video player; receiving user input associated with a first video frame of the plurality of video frames and a reference image, the first video frame including incomplete telemetry data: determining one or more coordinates associated with the first video frame based on user input associated with the first video frame and the reference image: determining the incomplete telemetry data associated with the first video frame based on the one or more determined coordinates; and generating a georegistration transform based on the determined telemetry data and the reference image: wherein the method is performed using one or more processors. For example, the method is implemented according to at least FIGS. 1, FIG. 2, FIG. 3, FIG. 5, FIG. 6, and/or FIG. 7.

In some embodiments, the method further comprises applying the georegistration transform to one or more video frames of the plurality of video frames to generate one or more registered video frames; and presenting the one or more registered video frames via the video player. In certain embodiments, the receiving user input associated with the first video frame and the reference image comprises receiving a first frame location on the first video frame and a first image location on the reference image. In some embodiments, the first frame location is received based on a click on the first video frame. In certain embodiments, the first image location is received based on a click on the reference image. In some embodiments, the first image location is determined by a machine learning model based on the first frame location and the reference image.

In certain embodiments, the receiving user input associated with the first video frame and the reference image comprises receiving a plurality of pairs of user inputs to the first video frame and the reference image, wherein each pair of user inputs includes a user input to the first video frame and a user input to the reference image. In some embodiments, the plurality of pairs of user inputs comprise three or more pairs of user inputs. In certain embodiments, the determining incomplete telemetry data associated with the first video frame comprises determining the incomplete telemetry data including at least one selected from a group consisting of a geospatial coordinate associated with the first video frame, a pointing angle of the image sensor, and a focal length of the image sensor.

In some embodiments, the receiving user input associated with the first video frame and the reference image comprises receiving user input via a prompt, where the determining one or more coordinates associated with the first video frame based on user input associated with the first video frame and the reference image comprises extracting a description from the prompt using a large language model. In certain embodiments, the georegistration transform is a first georegistration transform, wherein the method further comprises: identifying an anchor frame as a second video frame associated with the first video frame: determining a second georegistration transform based at least in part on the anchor frame.

In certain embodiments, the identifying an anchor frame comprises determining the second video frame meeting one or more selection criteria based on the first video frame. In some embodiments, the one or more section criteria comprises at least one selected from a group consisting of a criterion on a number of frames between the first video frame and the second video frame, a criterion on a difference between a second sensor characteristic associated with the second video frame and a first sensor characteristic associated with the first video frame. In certain embodiments, the incomplete telemetry data includes at least a piece of missing telemetry data or at least a piece of unreliable telemetry data. In some embodiments, the determining one or more coordinates associated with the video frame comprises: identifying a first frame location on the video frame; identifying a first image location on the reference image, wherein the first image location is associated with a set of geospatial coordinates; and determining a set of geospatial coordinates associated with the video frame based on the set of geospatial coordinates associated with the first image location.

According to certain embodiments, a system for georegistration is provided. In some embodiments, the system includes at least one processor, and at least one memory storing instructions that, when executed by the at least one processor, causes the system to perform a set of operations. In some embodiments, the set of operations includes: receiving a video stream including a plurality of video frames collected by an image sensor; presenting the video stream via a video player: receiving user input associated with a first video frame of the plurality of video frames and a reference image, the first video frame including incomplete telemetry data: determining one or more coordinates associated with the first video frame based on user input associated with the first video frame and the reference image: determining the incomplete telemetry data associated with the first video frame based on the one or more determined coordinates; and generating a georegistration transform based on the determined telemetry data and the reference image. For example, the system is implemented according to at least FIG. 1, FIG. 2, FIG. 3, FIG. 5, FIG. 6, and/or FIG. 7.

In some embodiments, the set of operations further comprises applying the georegistration transform to one or more video frames of the plurality of video frames to generate one or more registered video frames; and presenting the one or more registered video frames via the video player. In certain embodiments, the receiving user input associated with the first video frame and the reference image comprises receiving a first frame location on the first video frame and a first image location on the reference image. In some embodiments, the first frame location is received based on a click on the first video frame. In certain embodiments, the first image location is received based on a click on the reference image. In some embodiments, the first image location is determined by a machine learning model based on the first frame location and the reference image.

In certain embodiments, the receiving user input associated with the first video frame and the reference image comprises receiving a plurality of pairs of user inputs to the first video frame and the reference image, wherein each pair of user inputs includes a user input to the first video frame and a user input to the reference image. In some embodiments, the plurality of pairs of user inputs comprise three or more pairs of user inputs. In certain embodiments, the determining incomplete telemetry data associated with the first video frame comprises determining the incomplete telemetry data including at least one selected from a group consisting of a geospatial coordinate associated with the first video frame, a pointing angle of the image sensor, and a focal length of the image sensor.

In some embodiments, the receiving user input associated with the first video frame and the reference image comprises receiving user input via a prompt, where the determining one or more coordinates associated with the first video frame based on user input associated with the first video frame and the reference image comprises extracting a description from the prompt using a large language model. In certain embodiments, the georegistration transform is a first georegistration transform, wherein the method further comprises: identifying an anchor frame as a second video frame associated with the first video frame: determining a second georegistration transform based at least in part on the anchor frame.

In certain embodiments, the identifying an anchor frame comprises determining the second video frame meeting one or more selection criteria based on the first video frame. In some embodiments, the one or more section criteria comprises at least one selected from a group consisting of a criterion on a number of frames between the first video frame and the second video frame, a criterion on a difference between a second sensor characteristic associated with the second video frame and a first sensor characteristic associated with the first video frame. In certain embodiments, the incomplete telemetry data includes at least a piece of missing telemetry data or at least a piece of unreliable telemetry data. In some embodiments, the determining one or more coordinates associated with the video frame comprises: identifying a first frame location on the video frame; identifying a first image location on the reference image, wherein the first image location is associated with a set of geospatial coordinates; and determining a set of geospatial coordinates associated with the video frame based on the set of geospatial coordinates associated with the first image location.

According to certain embodiments, a method for georegistration is provided. In some embodiments, the method includes: receiving a video stream including a plurality of video frames collected by an image sensor: presenting the video stream via a video player; receiving user input associated with a first video frame of the plurality of video frames and a reference image, the first video frame including incomplete telemetry data, the incomplete telemetry data including at least a piece of missing telemetry data or at least a piece of unreliable telemetry data: determining one or more coordinates associated with the first video frame based on user input associated with the first video frame and the reference image: determining the incomplete telemetry data associated with the first video frame based on the one or more determined coordinates: generating a georegistration transform based on the determined telemetry data and the reference image: applying the georegistration transform to one or more video frames of the plurality of video frames to generate one or more registered video frames; and presenting the one or more registered video frames via the video player: wherein the method is performed using one or more processors. For example, the method is implemented according to at least FIGS. 1, FIG. 2, FIG. 3, FIG. 5, FIG. 6, and/or FIG. 7.

In some embodiments, the receiving user input associated with the first video frame and the reference image comprises receiving a first frame location on the first video frame and a first image location on the reference image. In some embodiments, the first frame location is received based on a click on the first video frame. In certain embodiments, the first image location is received based on a click on the reference image. In some embodiments, the first image location is determined by a machine learning model based on the first frame location and the reference image.

In certain embodiments, the receiving user input associated with the first video frame and the reference image comprises receiving a plurality of pairs of user inputs to the first video frame and the reference image, wherein each pair of user inputs includes a user input to the first video frame and a user input to the reference image. In some embodiments, the plurality of pairs of user inputs comprise three or more pairs of user inputs. In certain embodiments, the determining incomplete telemetry data associated with the first video frame comprises determining the incomplete telemetry data including at least one selected from a group consisting of a geospatial coordinate associated with the first video frame, a pointing angle of the image sensor, and a focal length of the image sensor.

In some embodiments, the receiving user input associated with the first video frame and the reference image comprises receiving user input via a prompt, where the determining one or more coordinates associated with the first video frame based on user input associated with the first video frame and the reference image comprises extracting a description from the prompt using a large language model. In certain embodiments, the georegistration transform is a first georegistration transform, wherein the method further comprises: identifying an anchor frame as a second video frame associated with the first video frame: determining a second georegistration transform based at least in part on the anchor frame.

In certain embodiments, the identifying an anchor frame comprises determining the second video frame meeting one or more selection criteria based on the first video frame. In some embodiments, the one or more section criteria comprises at least one selected from a group consisting of a criterion on a number of frames between the first video frame and the second video frame, a criterion on a difference between a second sensor characteristic associated with the second video frame and a first sensor characteristic associated with the first video frame. In some embodiments, the determining one or more coordinates associated with the video frame comprises: identifying a first frame location on the video frame: identifying a first image location on the reference image, wherein the first image location is associated with a set of geospatial coordinates; and determining a set of geospatial coordinates associated with the video frame based on the set of geospatial coordinates associated with the first image location.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system (e.g., one or more components of the processing system) to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented, for example, as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments. Various modifications and alterations of the disclosed embodiments will be apparent to those skilled in the art. The embodiments described herein are illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method for georegistration, the method comprising:
receiving a video stream including a plurality of video frames collected by an image sensor;
presenting the video stream via a video player;
receiving user input associated with a first video frame of the plurality of video frames and a reference image, the first video frame including incomplete telemetry data;
determining one or more coordinates associated with the first video frame based on user input associated with the first video frame and the reference image;
determining the incomplete telemetry data associated with the first video frame based on the one or more determined coordinates; and
generating a georegistration transform based on the determined telemetry data and the reference image;
wherein the method is performed using one or more processors.

2. The method of claim 1, further comprising:
applying the georegistration transform to one or more video frames of the plurality of video frames to generate one or more registered video frames; and
presenting the one or more registered video frames via the video player.

3. The method of claim 1, wherein the receiving user input associated with the first video frame and the reference image comprises receiving a first frame location on the first video frame and a first image location on the reference image.

4. The method of claim 3, wherein the first frame location is received based on a click on the first video frame.

5. The method of claim 4, wherein the first image location is received based on a click on the reference image.

6. The method of claim 4, wherein the first image location is determined by a machine learning model based on the first frame location and the reference image.

7. The method of claim 1, wherein the receiving user input associated with the first video frame and the reference image comprises receiving a plurality of pairs of user inputs to the first video frame and the reference image, wherein each pair of user inputs includes a user input to the first video frame and a user input to the reference image.

8. The method of claim 7, wherein the plurality of pairs of user inputs comprise three or more pairs of user inputs.

9. The method of claim 1, wherein the determining incomplete telemetry data associated with the first video frame comprises determining the incomplete telemetry data including at least one selected from a group consisting of a geospatial coordinate associated with the first video frame, a pointing angle of the image sensor, and a focal length of the image sensor.

10. The method of claim 1, wherein the receiving user input associated with the first video frame and the reference image comprises receiving user input via a prompt, wherein the determining one or more coordinates associated with the first video frame based on user input associated with the first video frame and the reference image comprises extracting a description from the prompt using a large language model.

11. The method of claim 1, wherein the georegistration transform is a first georegistration transform, wherein the method further comprises:
identifying an anchor frame as a second video frame associated with the first video frame;
determining a second georegistration transform based at least in part on the anchor frame.

12. The method of claim 11, wherein the identifying an anchor frame comprises determining the second video frame meeting one or more selection criteria based on the first video frame.

13. The method of claim 12, wherein the one or more section criteria comprises at least one selected from a group consisting of a criterion on a number of frames between the first video frame and the second video frame, a criterion on a difference between a second sensor characteristic associated with the second video frame and a first sensor characteristic associated with the first video frame.

14. The method of claim 1, wherein the incomplete telemetry data includes at least a piece of missing telemetry data or at least a piece of unreliable telemetry data.

15. The method of claim 1, wherein the determining one or more coordinates associated with the video frame comprises:
identifying a first frame location on the video frame;
identifying a first image location on the reference image, wherein the first image location is associated with a set of geospatial coordinates; and
determining a set of geospatial coordinates associated with the video frame based on the set of geospatial coordinates associated with the first image location.

16. A system for georegistration, the system comprising:
at least one processor; and
at least one memory storing instructions that, when executed by the at least one processor, causes the system to perform a set of operations, the set of operations comprising:
receiving a video stream including a plurality of video frames collected by an image sensor;
presenting the video stream via a video player;
receiving user input associated with a first video frame of the plurality of video frames and a reference image, the first video frame including incomplete telemetry data;
determining one or more coordinates associated with the first video frame based on user input associated with the first video frame and the reference image;
determining the incomplete telemetry data associated with the first video frame based on the one or more determined coordinates; and
generating a georegistration transform based on the determined telemetry data and the reference image.

17. The system of claim 16, wherein the set of operations further comprises:
applying the georegistration transform to one or more video frames of the plurality of video frames to generate one or more registered video frames; and
presenting the one or more registered video frames via the video player.

18. The system of claim 16, wherein the receiving user input associated with the first video frame and the reference image comprises receiving a first frame location on the first video frame and a first image location on the reference image.

19. The system of claim 16, wherein the determining incomplete telemetry data associated with the first video frame comprises determining the incomplete telemetry data including at least one selected from a group consisting of a geospatial coordinate associated with the first video frame, a pointing angle of the image sensor, and a focal length of the image sensor.

20. A method for georegistration, the method comprising:
receiving a video stream including a plurality of video frames collected by an image sensor;
presenting the video stream via a video player;
receiving user input associated with a first video frame of the plurality of video frames and a reference image, the first video frame including incomplete telemetry data, the incomplete telemetry data including at least a piece of missing telemetry data or at least a piece of unreliable telemetry data;
determining one or more coordinates associated with the first video frame based on user input associated with the first video frame and the reference image;
determining the incomplete telemetry data associated with the first video frame based on the one or more determined coordinates;
generating a georegistration transform based on the determined telemetry data and the reference image;
applying the georegistration transform to one or more video frames of the plurality of video frames to generate one or more registered video frames; and
presenting the one or more registered video frames via the video player;
wherein the method is performed using one or more processors.
